(19) United States
(12) Patent Application Publication
(10) Pub. No.: US 2005/0255294 A1
(43) Pub. Date: Nov. 17, 2005

(54) Method and apparatus for forming sheet material and sheet material formed thereby

(75) Inventor: William H. Goodger, Dix Hills, NY (US)

Correspondence Address: CASELLA & HESPOS, 274 MADISON AVENUE, NEW YORK, NY, 10016, US

(73) Assignee: Stanbee Company, Inc., Carlstadt, NJ (US)

(21) Appl. No.: 11/125,770

(22) Filed: May 10, 2005

Related U.S. Application Data
(60) Provisional application No. 60/570,159, filed on May 12, 2004.
(60) Provisional application No. 60/577,962, filed on Jun. 8, 2004.

(51) Int. Cl. B32B 3/02

(52) U.S. Cl. 428/157

(57) ABSTRACT

A method and an apparatus are provided for forming sheet material that can be used as a stiffener. The sheet material may be unitary and is formed from a material that exhibits appropriate resiliency, stiffness and shape retention. The sheet material preferably is formed with a profiled die so that at least one edge of the stiffener is chamfered. The profiled forming and cutting die may be part of press or part of a roll former.

This application relates to Provisional Patent Application No. 60/570,159 filed May 12, 2004 and Provisional Patent Application No. 60/577,962 filed on Jun. 8, 2004.

### BACKGROUND OF THE INVENTION

1. Field of the Invention

The invention relates to a method and apparatus for forming sheet material, and particularly sheet material that can be used as a stiffener. The sheet material can be used in many manufacturing processes, including, for example the manufacture of footwear, hats, luggage, golf bags and clothing, to name a few.

2. Description of the Related Art

Stiffeners are used in the footwear to provide varying degrees of resilience, stiffness and shape retention in the heel and toe portions of the footwear. These materials often are made from a needle punched non-woven fabric or a woven fabric. The fabric alone generally does not provide the desired degrees of resiliency, stiffness and shape retention. Hence, the fabric is treated with a resin, such as latex, to provide appropriate resiliency, stiffness and shape retention.

Several optional manufacturing processes have been used to provide the necessary resiliency, stiffness and shape retention to the stiffeners for shoes and sneakers. For example, some manufacturers pass a web of the woven or non-woven fabric from a roll through a bath of latex resin. The latex resin saturates the fabric. The saturated fabric then is passed from the bath and passes through heating devices for curing. Other manufacturing processes apply a latex powder to the woven or non-woven fabric rather than passing the fabric through a bath. The fabric then is heated sufficiently for the latex powder to melt into the fabric. Still other manufacturing processes extrude a coating of latex onto the non-woven fabric.

The stiffener typically must be adhered to adjacent layers of the footwear. Thus, the latex-saturated non-woven fabric typically is treated with a hot melt coating to provide a finished stiffener that has adhesive properties. Accordingly heat and/or pressure applied during the footwear manufacturing process will bond the stiffener to inner and outer layers of the footwear.

Stiffeners for footwear typically are made by manufacturers with special expertise in this technology. The manufacturers form the stiffeners from long rolled webs of non-woven fabric. The long webs then are cut into rectangular sheets that are stacked on a pallet, wrapped and transported to the manufacturer of the footwear. The footwear manufacturer then stamps out small blanks from the large sheets to form stiffeners of appropriate dimensions for the heel and/or toe portion of the footwear. The stiffener for the heel portion of the footwear generally is referred to as a heel counter, while the stiffener for the toe portion of the footwear generally is referred to as a box toe.

FIGS. 1 and 2 herein show the blank of a stiffener that eventually will extend across the heel portion of a shoe or sneaker. In this context, the term blank indicates that the heel counter has been cut from a larger sheet but has not been processed and formed completely. FIG. 2 shows that the blank 100 for the heel counter has opposed parallel top and bottom surfaces 101 and 102 and edges 103 and 104 that extend perpendicularly between the top and bottom surfaces 101 and 102. The blank 100 could be incorporated into a shoe or sneaker in this form. However, at least one of the edges 103 and 104 that will extend around the heel of the foot and will form a well defined line in the footwear. The well defined line is aesthetically unacceptable to most footwear manufacturers. Additionally, the well defined edge 103 or 104 can present discomfort to the wearer. Similar problems exist with box toes. As a result, most footwear manufacturers perform a skiving operation on at least one edge of the stiffener before incorporating the stiffener into the footwear. The skiving operation is slow and labor intensive and requires the stiffener blank 100 to be fed into a skiving machine that will convert the blank 100 shown in FIGS. 1 and 2 into a stiffener 106 or 108 with a cross-sectional shape as shown in FIG. 3 or 4. The skiving operation creates the potential for mistake, and hence post-skiving quality control is essential.

The stamping operation that is used to form the blanks 100 necessarily leaves a substantial amount of waste material as the blanks 100 are cut from the sheet. The skiving operation also creates a substantial amount of waste material, and the quality control checking typically identifies rejects that constitute waste. Waste produced during the manufacture of shoe stiffeners can be recycled due to environmental concerns of the shoe manufacturer and/or environmental laws of the governmental jurisdiction in which the shoe manufacturing is carried out. The shoe manufacturer typically will not have the interest or ability to undertake a recycling of the scrap stiffener materials. Hence, the shoe manufacturers typically return the scrap to the manufacturer of the stiffener materials for recycling.

The large sheets of stiffeners produced by the above-described prior art manufacturing processes typically is highly automated and often is carried out in more industrialized areas of the world. Other aspects of shoe manufacturing, including the skiving operations, are more labor intensive and hence often are carried out in less industrialized areas of the world. Thus, it is not uncommon for the sheets of stiffeners to be made in Europe or North America. The sheets then are transported long distances to areas of the world that have cheaper sources of labor. The scrap material then is transported back to the source of the sheet material. Hence, there are substantial shipping costs relating to portions of the stiffeners that are not used. The shoe manufacturing industry is highly competitive, and even small savings in cost can lead to a significant competitive advantage. Thus, processes that reduce or eliminate the transport of excess stiffener materials could be commercially very beneficial to the manufacturers of stiffeners.

Significant competition also exists among the shoe manufacturers. Hence, there is a commercial advantage to reducing the costly labor intensive aspects of shoe manufacturing, such as the above-described skiving operations and quality control checking.

The footwear industry was the focus of the preceding discussion of sheet materials and stiffeners. However, other industries employ sheet materials that must have specified stiffness, resiliency and shape retention characteristics. For example, sheet materials with specified stiffness, resiliency and shape retention characteristics are used in hats, purses, luggage, back packs, golf bags, clothing and many other products. Accordingly, an object of the invention is to provide a method for manufacturing sheet material, such as stiffeners, in a more efficient manner.

It is another object of the subject invention to provide an apparatus for efficiently manufacturing sheet material that must be cut and formed, such as the sheet material used in heel counters and box toes of footwear.

### SUMMARY OF THE INVENTION

The invention relates to a process and apparatus for making profiled sheet material, such as sheet material that may be used for stiffening selected areas of footwear. The process includes forming a sheet material having appropriate stiffening, resiliency and shape retention characteristics for the specified end use. The process then includes cutting the sheet material into blanks with specified shapes and substantially simultaneously forming the cut blanks of sheet material to have the required profile. The forming step preferably is carried out to provide at least one chamfered edge on the sheet material.

The cutting and forming may be carried out with a stamping apparatus or with a rotary cutter. The stamping apparatus or the rotary cutter may include at least one continuous cutting edge for cutting through the sheet material. The stamping apparatus or the rotary cutter also may have a profiled region substantially bounded by the cutting edge. The cutting edge and the profiled region cut the sheet material into small blanks of specified shapes and substantially simultaneously form the cut blanks of the sheet material to have the specified profile. The forming aspect of the process may be carried out to define the above-referenced chamfer along at least one of the cut edges.

Embodiments of the invention that employ rotary cutters may cut sections of the sheet material from an elongate web while the web is fed longitudinally and continuously through the rotary cutter. Embodiments of the invention that employ a stamping press may cut the sections of the sheet material from an elongate web of sheet material as the sheet material is fed incrementally into and through the stamping press.

The formation of the specified profile on the blanks of sheet material requires some movement or flowing of the sheet material as part of the forming process. The cutting and forming of the blank of the sheet material can be carried out more easily if the sheet material is sufficiently warm to permit flowing of the sheet material in response to forces exerted by the forming and cutting die. Thus, the forming and cutting step of the process preferably is carried out before the sheet material is cured completely. Alternatively, the sheet material may be heated prior to forming and cutting to ensure that the sheet material can be formed without excessive pressure.

The sheet material that is subject to forming and cutting may be the above-described fabric that has been saturated with a resin. However, a preferred embodiment employs an extruded resin rather than a resin saturated fabric. The extrusion process enables a unitary matrix of resin to be formed with specified stiffening characteristics and with specified adhesive characteristics. Furthermore, the extruded resin is more easily formable than the resin saturated fabric. The apparatus for forming the resin web preferably includes an adjustable lip die to permit the thickness of the resin web to be varied in accordance with the specification of the finished product.

The process and apparatus of the invention eliminates the labor intensive skiving operations associated with the prior art. Hence, the stiffeners such as heel counters or box toes can be formed easily with a high degree of automation at the location at which the sheet material is formed. The profiled stiffeners then can be shipped to the site for manufacturing the finished product without the need to transport waste portions of the web to the site of manufacturing and then to transport waste portions of the web back to its origin for recycling. Hence, the subject invention results in very substantial reductions in shipping costs, and corresponding reductions in overall costs. For example, waste of the web may be ground up or otherwise processed at the site of the web production. Particles derived from the waste of the web may be heated or otherwise processed to achieve proper moisture content and then may be re-deposited directly back into the extruder.

The process and apparatus of the invention achieves many other manufacturing efficiencies. For example, prior art processes typically require complicated and costly compounding of powders for coating onto a fabric web. Those process steps are entirely unnecessary with preferred embodiments of the subject invention. Prior art processes also often require mixing of hot melts for application to a fabric web. The costs and time associated with mixing and applying the hot melt coating is avoided with preferred embodiments of the subject invention. Processes that involve saturating a fabric web also require large ovens for drying the fabric web. The ovens take up a substantial amount of floor space in a manufacturing facility and require significant amounts of energy to operate. In contrast, preferred embodiments of the subject process and apparatus may rely largely upon the heat imparted to the web as part of the extrusion process. Any reheating that may be required to soften the web prior to forming and cutting is less than the heat required for drying the saturated web. Hence, heaters used with the apparatus of the subject invention are preferably smaller and more energy efficient. Still further, the subject invention avoids the sheeting that is an integral part of prior art processes. In particular, the prior art webs are cut into rectangular sheets for shipment to a separate manufacturing facility. The sheets then are fed sequentially into a stamping apparatus. In contrast, the subject invention enables finished products to be formed and cut substantially simultaneously and directly from the web. The separate sheeting process is not required. Recycling also is much more efficient. Unused parts of the web can be recycled directly into the hopper of the extruder. Prior art processes typically must include a cryogenic grinding process or some other complex grinding process for the waste material.

An alternate apparatus and method in accordance with the invention avoids the initial formation and/or use of sheet material prior to making the profiled blanks. In this regard, the apparatus may include first and second rolls defining a nip therebetween. The first roll may have a smooth outer surface. The second roll, however, is formed with an array of inwardly directed die recesses corresponding to the specified shapes of the profiled blanks. Areas between their respective die recesses are disposed to substantially contact the smooth outer surface of the first roll at the nip between the first and second rolls. The apparatus of this embodiment is employed by depositing a flowable resin at the leading side of the nip between the rolls. Rotation of the rolls forces the resin into the die recesses in the second roll and hence forms the resin material into shapes corresponding to the specified profile for the blanks. Further rotation of the rolls moves the profiled blanks away from the nip and enables the blanks to be separated from the second roll and transported to an appropriate location for quality control, packaging and shipment to a customer.

The alternate apparatus may further include a retainer disposed in the interstice at the downstream side of the nip. The retainer has a shape substantially conforming to the shape of the interstice and functions to keep the flowable resin in the die recesses while the resin is curing sufficiently to be separated from the die recesses of the second roll. A specified flowability and curing can be achieved at appropriate times during the process by heating the first roll and/or by cooling the second roll and the retainer. The heating of the first roll helps to maintain flowability of the resin as the resin approaches the upstream side of the nip. The cooling of the second roll and the cooling of the retainer helps to cure the resin after the resin has been urged into the respective die recesses.

The apparatus and method of the alternate embodiment described above achieves all of the advantages of the first embodiment. However, the alternate embodiment offers still further advantages. In particular, the process of the alternate embodiment avoids the need and expense for an extruder that first forms a web of material. Rather, the resin is fed directly into the nip between the first and second rollers. Second, the alternate embodiment produces virtually no waste that would otherwise require recycling. In contrast, the first embodiment and the above-described prior art yield significant amounts of waste at locations on the web between the blanks that are cut according to the prior art process or roll formed according to the first embodiment.

### BRIEF DESCRIPTION OF THE DRAWINGS

FIG. 1 is a top plan view of a prior stiffener blank that can be fabricated further for use in the manufacture of footwear.

FIG. 2 is a cross-sectional view taken along line 2-2 in FIG. 1.

FIG. 3 is a cross-sectional view similar to FIG. 2, but showing one edge of the blank after skiving so that the blank is fabricated sufficiently for use in certain footwear.

FIG. 4 is a cross-sectional view similar to FIGS. 2 and 3, but showing a prior art blank skived on all sides and rendered suitable for use in certain footwear.

FIG. 5 is a schematic view of an apparatus in accordance with a first embodiment of the subject invention.

FIG. 6 is a perspective view of a rotary forming and cutting die used in the apparatus of FIG. 5.

FIG. 7 is a cross-sectional view taken along line 7-7 in FIG. 6.

FIG. 8 is a cross-sectional view of a blank formed by the die of FIG. 7.

FIG. 9 is a cross-sectional view similar to FIG. 7, but showing a die with a different shape.

FIG. 10 is a cross-sectional view of a blank formed by the die of FIG. 9.

FIG. 11 is a perspective view similar to FIG. 6, but showing an alternate rotary forming and cutting die.

FIG. 12 is a schematic view of a portion of an alternate apparatus that can be used to practice the method of the subject invention.

FIG. 13 is a schematic view of an apparatus that can be used with the apparatus of FIG. 12.

FIG. 14 is a top plan view of an apparatus in accordance with a further embodiment of the invention.

FIG. 15 is a cross sectional view taken along line 15-15 in FIG. 14.

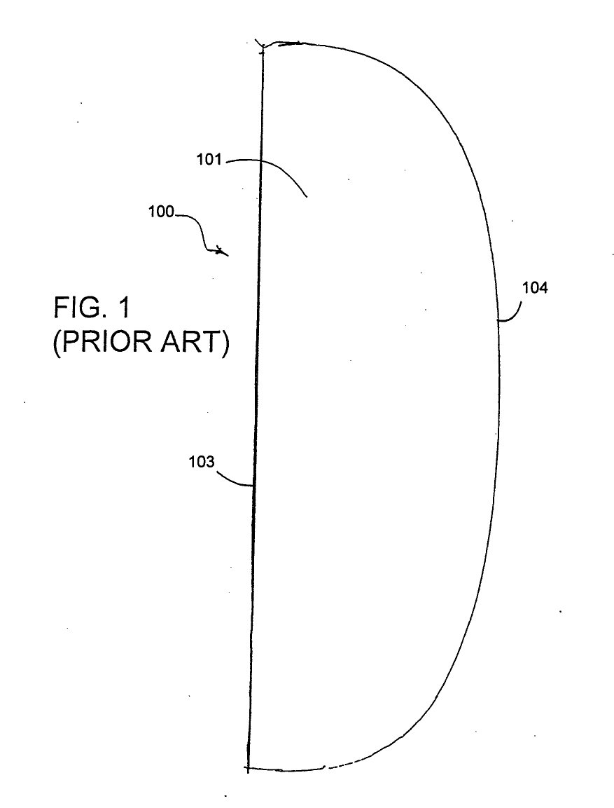

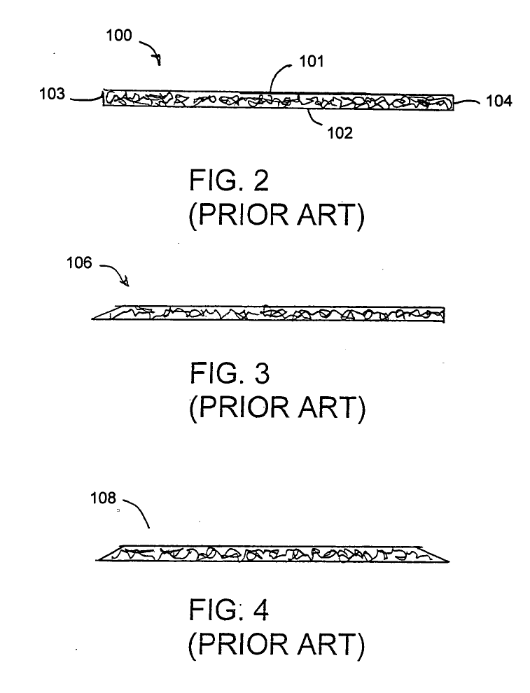

### DETAILED DESCRIPTION OF THE PREFERRED EMBODIMENTS

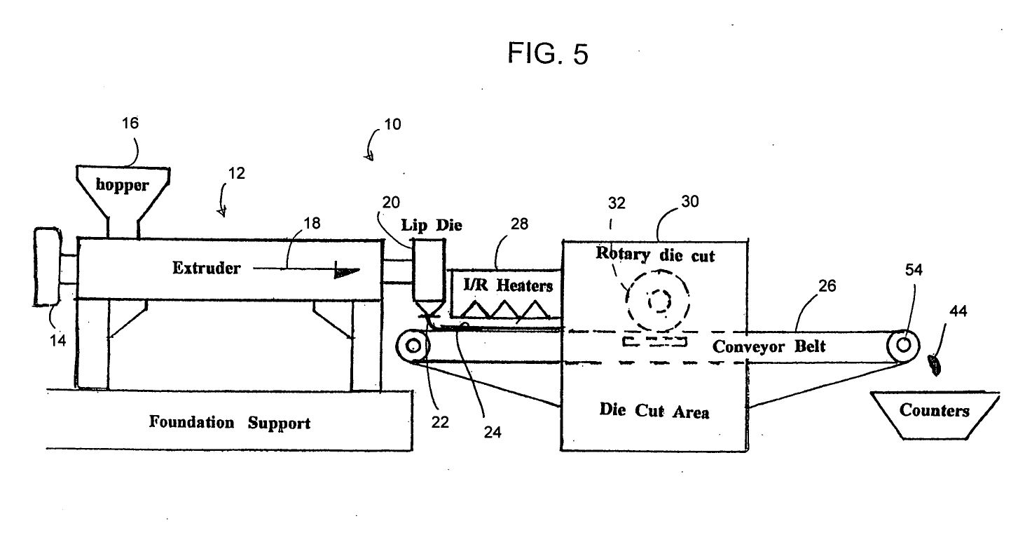

An apparatus in accordance with a first embodiment of the invention is identified generally by the numeral 10 in FIG. 5. The apparatus 10 includes an extruder 12 with a screw (not shown) driven by a motor 14. The extruder 12 further includes a hopper 16 for loading controlled amounts of appropriate resins into the extruder 12. The resin is selected to meet the requirements of the finished product, and may be a polycaprolactone, PETG, ABS, EVA, polyester or the like. The screw driven by the motor 14 is operative for advancing the flowable resin in the direction of the arrow 18. The extruder 12 further includes a die 20 with a pair of spaced-apart lips to define an outlet slot 22. Resin is extruded through the slot 22 to define a web 24. At least one of the lips of the slot 22 preferably is adjustable toward and away from the other lip that defines the slot 22. Thus, the thickness of the web 24 extruded from the die 20 can be varied through a range of about 15-150 mils by moving at least one of the lips that define the slot 22 of the die 20.

The web 24 produced by the extruder 12 is deposited onto a conveyor 26 that moves the web 24 away from the extruder. A heating station 28 is in proximity to the conveyor 26 and prevents the web 24 from curing and solidifying into its stiffened state. The heating station 28 may include an array of infrared heaters that function to maintain the resin web 24 in a semi-molten soft state and hence readily deformable in response to pressure thereon. However, the web 24 is not heated sufficiently to generate flow or dimensional changes in the absence of pressure. Hence, the thickness of the web 24 passing through the heating station 28 can be controlled.

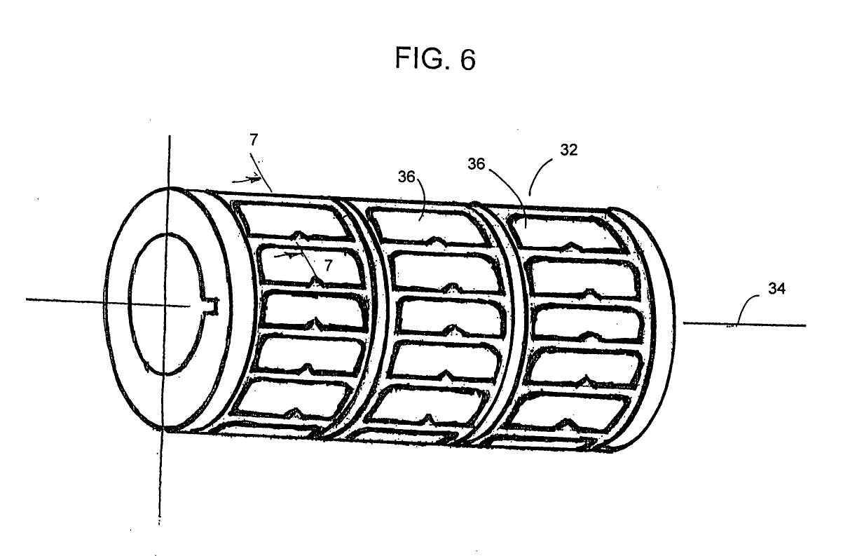

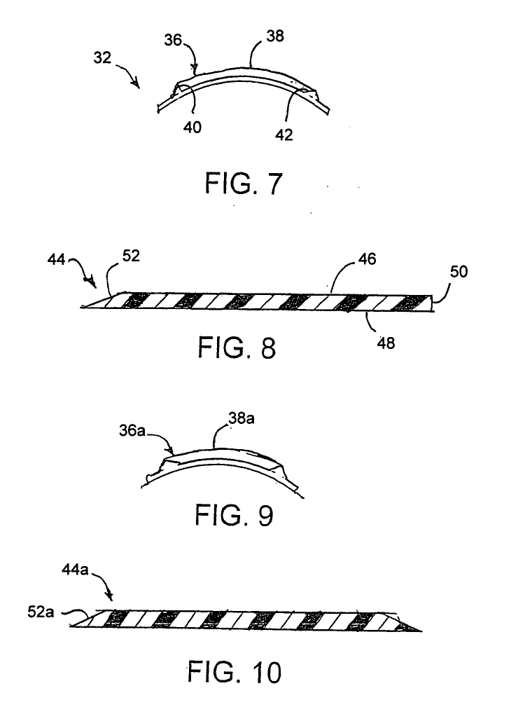

The apparatus 10 further includes a forming and cutting station 30 substantially adjacent the downstream end of the heating station 28. The forming and cutting station 30 of the apparatus 10 includes a rotary forming and cutting die 32 as shown most clearly in FIG. 6. More particularly, the rotary forming and cutting die 32 is generated substantially cylindrically about an axis 34 aligned substantially perpendicular to the direction of movement of the web 24 along the conveyor 26 and substantially parallel to the plane define by the web at locations adjacent the rotary forming and cutting die 32. The rotary forming and cutting die 32 includes a cylindrical outer sleeve with a plurality of forming and cutting die sets 36 formed thereon. Each forming and cutting die set 36 includes a continuous peripheral cutting edge 38 that is sufficiently sharp and has a sufficient extension to cut completely though the web 24. Portions of the die set 36 inwardly from cutting edge 38 are recessed relative to the outer projecting end of the cutting edge 38 for receiving portions of the resin web 24 inwardly from the continuous cutting edge 38. Additionally, portions of the die set 36 adjacent at least a portion of the cutting edge 38 are configured to define a chamfer along at least one edge of the section of the web 24 cut by the die set 36. For example, FIG. 7 shows that the cutting edge 38 of one die set 36 includes an inwardly facing surface 40 aligned substantially radially. However, another portion of the cutting edge 38 includes an inwardly facing chamfered surface 42 aligned at an acute angle to the outer circumferential surface of the rotary forming and cutting die 32.

The die set 36 produces a blank 44, as shown in FIG. 8. The blank 44 has opposite surfaces 46 and 48 and defines a uniform matrix of the resin substantially free voids that exist with stiffeners are made from a woven or nonwoven fibers. An edge 50 is produced by the radially aligned section 40 of the cutting edge 38 and extends orthogonally between the surfaces 46 and 48. However, the blank 44 also has a chamfered edge 52 produced by the chamfered portion 42 of the cutting edge 38. Thus, the radially aligned section 40 of the cutting edge 38 will produce a right angle cut through the thickness of the web 24. However, the chamfered section 42 of the cutting edge 38 will simultaneously cut and deform the web 24 to form a chamfer along at least one edge of the cut section of the web 24. The chamfer 52 preferably defines a small acute angel of less than about 20°, and most preferably about 5°-10°. Additionally, the chamfered surface 52 will be smooth and free of cut marks skiving marks.

FIG. 9 shows a further embodiment of the sleeve 32 with a die set 36a and a cutting edge 38a that is chamfered about the entire periphery of the die set 36a. The die set 36a of FIG. 9 will produce blanks 44a from the resin web 24 with a chamfer 52a extending about the blank 44a, as shown in FIG. 10. All portions of each die set 36, 36a may be coated with a material, such as PTFE, that will facilitate separation of the blank 44, 44a.

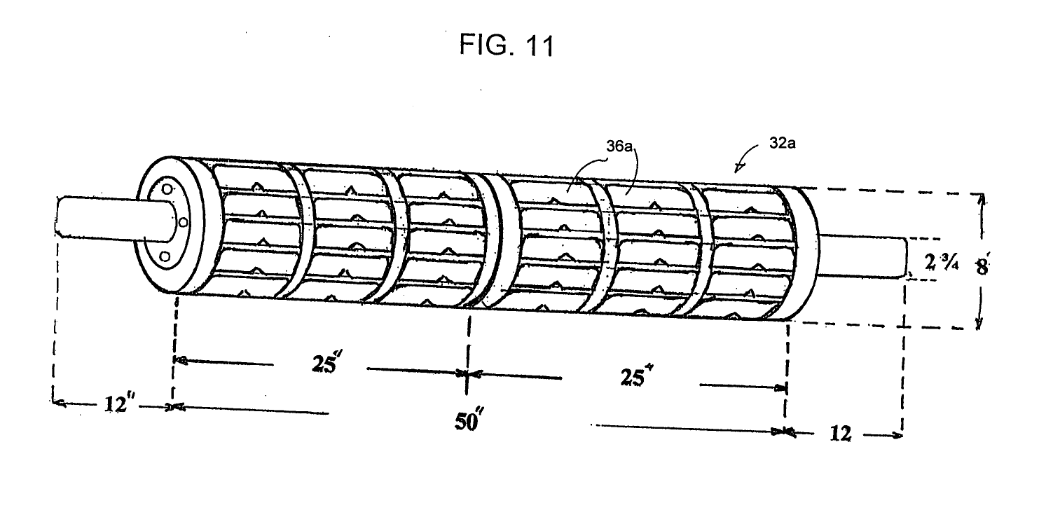

The rotary cutting and forming die 32 shown in FIG. 6 includes three circumferential arrays of die sets 36. However, other arrangements of die sets can be provided. For example, FIG. 11 shows a rotary forming and cutting die 32a with a total of six circumferential arrays of die sets 36a. FIGS. 6 and 11 show all of the die sets 36 on the rotary forming and cutting die 32 being substantially identical. However, some of the die sets 36 can be different from others. The differences may relate entirely to dimensions. Thus, one die sets 36 may be used for producing heel counters for a large shoe, while another die set 36 may be used for producing heel counters for a smaller shoe. Alternatively, die sets 36 may differ to produce different types of products. For example, one circumferential array of die sets 36 can produce heel counters, while an adjacent circumferential section can produce box toes. The die sets 36 can be parts of sleeves that can be mounted removably on a mandrel to enable the forming and cutting of different blanks. Additionally, the rotary forming and cutting die 32, 32a can be in communication with a supply of cool water. Thus, the blanks 44, 44a can be chilled and at least partly cured during the forming and cutting process.

The conveyor 26 extends downstream from the forming and cutting station 30 and then wraps around a drive roll 54. As a result, blanks 44 or other cut sections are deposited into an appropriate receptacle, while remaining portions of the web 24 are sent to a different receptacle for recycling.

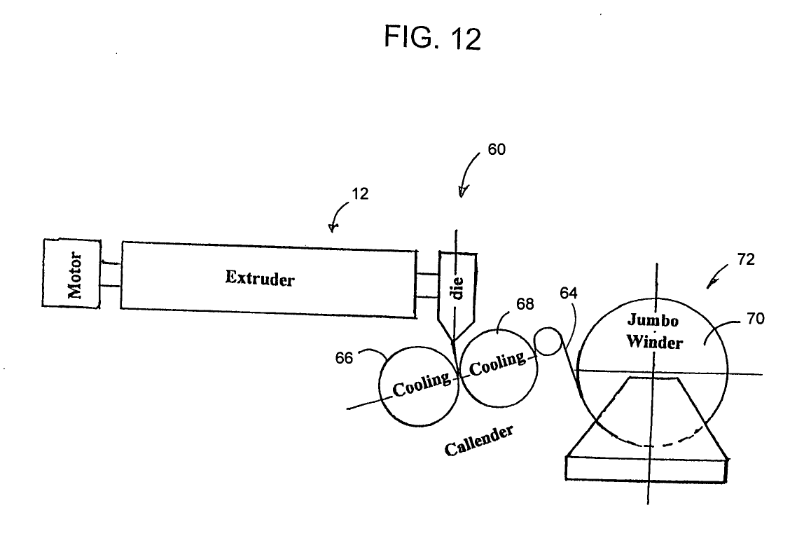

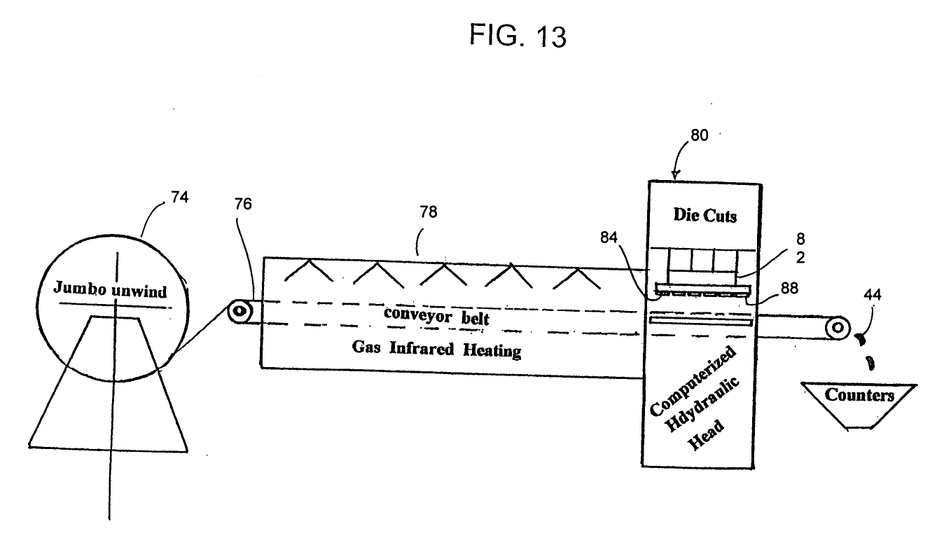

FIGS. 12 and 13 show an alternate apparatus 60 for practicing a method according to the subject invention. The apparatus 60 includes an extruder 62 that may be substantially identical to the extruder 12 illustrated in FIG. 5 and described above. A web 64 produced by the extruder may be substantially identical to the web 24 produced by the extruder 12. However, in the embodiment of FIGS. 12 and 13, the web 64 is passed between and around cooling rolls 66 and 68 to cure the resin web 64. The resin web 64 then is wound onto a roll 70 at a winding station 72. The roll 70 then may be moved to an unwind station 74, as shown in FIG. 13. The web 64 is unwound from the roll 70 at the unwind station 74 and is passed along a conveyor 76 through a heating section 78. The heating station 78 may include a gas infrared heater station. The function of the heating station 78 is to soften the previously cured web 64 so that the resin in the web 64 is rendered soft and easily formable.

The apparatus 60 further includes a forming and cutting station 80. In this embodiment, the forming and cutting station 80 includes a stamp forming and cutting press 82 that moves toward and away from the web 64 and in directions substantially perpendicular to the direction of movement of the web 64 along the conveyor 76. The stamp forming and cutting press 82 includes a plurality of die sets 84, each of which has a peripheral cutting edge 88 similar to the cutting edge 38 on the die sets 36 of the rotary forming and cutting die 32. The cutting edges 88 are dimensioned to pass completely through the web 64. Additionally, areas of each die set 84 bounded by the cutting edge 88 are configured to form a specified profile. In this regard, the cutting edge 88 may include a first section where an inner surface of the cutting edge 88 is aligned parallel to the direction of movement of the stamp forming and cutting press 82. However, a second section is aligned at an acute angle to the direction of movement of the stamp forming and cutting press 82 to form a chamfer 52 along at least one edge, as shown in FIG. 8. Alternatively, the cutting edge 88 may have a continuous chamfered inner face extending entirely thereabout to produce a blank with a continuous chamfer, as shown in FIG. 10.

The portion of the apparatus 60 shown in FIG. 12 differs from the first embodiment in that the web 64 is advanced incrementally along the conveyor 76. In particular, the web 64 is indexed into a position aligned with the forming and cutting station 80. The press 82 in the forming and cutting station 80 then is actuated to form and cut a plurality of blanks 44 from the web 64. The press 82 then is lifted up and away from the web 64 and the conveyor belt 76 indexes the web 64 sufficiently to align a new section with the forming and cutting station 80. The conveyor 76 includes a roll 89 downstream from the forming and cutting station 80 which generates a greater than 90° change in direction of the conveyor 64. Cut and formed blanks 44 with profiles as shown in FIG. 8 or 10 then are deposited in an appropriate receptacle, as in the first embodiment. Waste portions of the web 64 then are sent to another location for recycling as described with respect to the first embodiment.

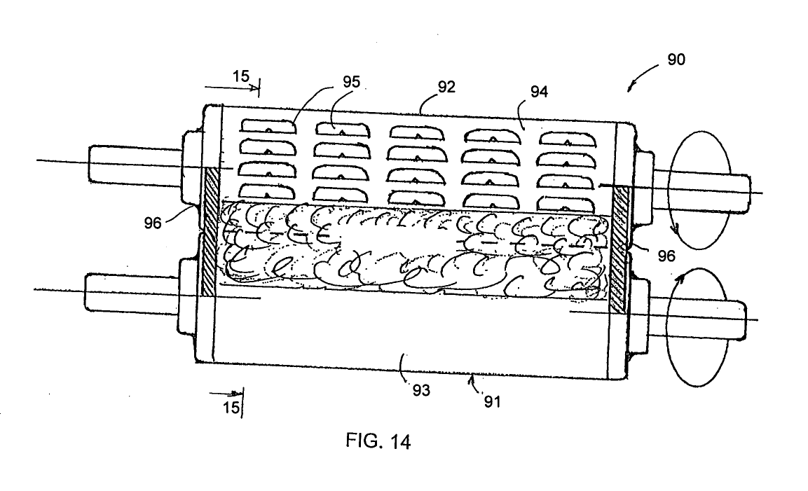

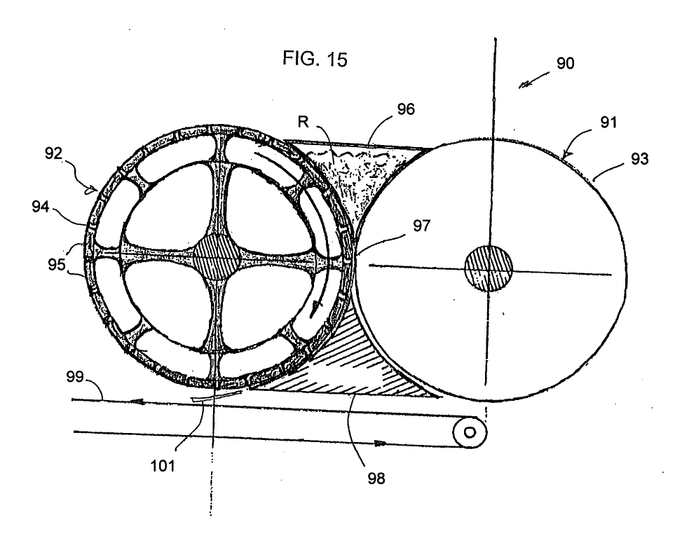

A further embodiment of an apparatus in accordance with the invention is identified generally by the numeral 90 in FIGS. 14 and 15. The apparatus 90 includes a first roll 91 and a second roll 92 that are rotatable in opposite directions about parallel axes. The first roll 91 includes a smooth cylindrical outer surface 93. However, the second roll 92 includes an outer surface 94 formed from a plurality of die recesses with shapes corresponding to the specified shapes of the profiled blanks specified for a particular article of manufacture (e.g. a heel counter). The apparatus further includes end dams 96 at opposite longitudinal ends of the rolls 91 and 92 for channelizing a flow of resin R into a nip 97 defined between the rolls 91 and 92. The apparatus further includes a retainer 98 at the outlet side of the interstice define by the nip 97 between the rolls 91 and 92. As shown in FIG. 15, the first and second rolls 91 and 92 are arranged with their axes in a substantially horizontal plane and rotate so that the upstream entry to the nip 97 is gravitationally above the axes. The retainer 98, therefore, is gravitationally below the nip 97 between the rolls 91 and 92. A conveyor belt 99 or other transportation means is provided below the retainer 98 and the second roll 92.

As shown most clearly in FIG. 15, the apparatus 90 is employed by depositing a flowable resin compound R in the upstream interstice between the rolls 91 and 92 and above the nip 97 between the rolls 91 and 92. The first roll 91 is heated to maintain the flowing characteristics of the resin R entering the nip 97. The resin R is urged by forces of gravity and by forces of the rotating rolls 91 and 92 into the die recesses 95 in the outer surface 94 of the second roll 92. Hence, the resin R will adopt the specified profile of the profiled blanks 101. The second roll 92 and the retainer 98 are cooled to facilitate curing of the resin R that has been urged into the die recesses 95. The profiled blanks 101 then advance beyond the retainer 98 and are deposited gravitationally onto the conveyor belt 99 for transportation to an appropriate location where the profiled blanks 101 can be packaged and shipped to the manufacturer.

The alternate method illustrated in FIGS. 14 and 15 avoids the need to initially extrude a sheet of material that is subsequently formed and separated from the sheet as part of the forming process. Hence, the alternate apparatus and method depicted with respect to FIGS. 14 and 15 results in substantial space savings in a manufacturing facility because there is no need for an extruder or for rolls or conveying systems to transport the extruded web to the roll forming dies. Additionally, the apparatus of the subject invention produces virtually no waist that requires recycling. In this regard, portions of the outer surface 94 of the second roll 92 between the recesses 95 substantially contact the outer surface 93 of the first roll 91 at the nip 97. Hence, only portions of the resin R in the die recesses 95 will move through the nip 97 and there will be virtually no waste traveling downstream from the nip 97.

1. A stiffener for use in manufacturing shoes, the stiffener being formed unitarily from a uniform matrix of resin material having opposite substantially parallel surfaces and an edge extending between the surfaces, at least a portion of the edge being chamfered.

2. A method for forming a stiffener comprising:
extruding a resin material to define a resin web; and
presenting the web to a forming and cutting die for cutting the web into sheets having an outer peripheral edge defining a specified shape for the stiffener and simultaneously chamfering at least one portion of the peripheral edge.

3. The method of claim 2, wherein the web has a thickness in a range of 15-150 mils.

4. The method of claim 2, further comprising a step of maintaining the web at a selected temperature prior to presenting the web to the forming and cutting die, the temperature being selected to prevent flowing of the resin in the absence of external forces thereon while facilitating the chamfering of the resin in response to forming forces exerted by the forming and cutting die.

5. The method of claim 2, wherein the forming and cutting die is mounted to a press, the method including the step of operating the press to move the forming and cutting die substantially perpendicular to the web and incrementally advancing the web with each movement of the forming and cutting die away from the web.

6. The method of claim 2, wherein the forming and cutting die is a rotary forming and cutting die that is rotatable about an axis substantially parallel to the web the step of presenting the web to the forming and cutting die includes advancing the web substantially continuously towards the forming and cutting die.

7. The method of claim 2, wherein the step of extruding the web includes feeding the resin into a hopper upstream of an extrusion die and urging the resin through the extrusion die, the method further including separating the stiffeners produced by the forming and cutting die and leaving waste material of the web, reprocessing waste material remaining after separating the stiffener and feeding the reprocessed waste material into the hopper upstream of the extrusion die.

8. A method for forming sheet shaped stiffeners comprising:
providing a first roll and a second roll aligned substantially parallel to one another to define a nip therebetween, one of said rolls being formed with a plurality of die recesses thereon, said die recesses defining shapes for said stiffener;
rotating said rolls in opposite direction so that surfaces of said roll approach one another at an upstream side of said nip and diverge from one another at a downstream side of said nip;
feeding a flowable resin material into the upstream side of the nip so that the resin flows into the die recesses and moves through the nip; and
separating the resin from the die recesses at the downstream side of the nip to form the stiffeners.

9. The method of claim 8, further comprising cooling the resin in the die recesses on the downstream side of the nip.

10. The method of claim 9, further comprising providing a retainer substantially at the downstream side of the nip, the step of cooling the resin including cooling the retainer.
